(19) United States
(12) Patent Application Publication
(10) Pub. No.: US 2016/0056004 A1
(43) Pub. Date: Feb. 25, 2016

(54) ELECTRICAL PROTECTION ASSEMBLY

(71) Applicant: The Trustees for the Time Being of the Philip Edward Lawrence Risi Trust, North West Province (ZA)

(72) Inventor: Philip Edward Lawrence RISI, North West Province (ZA)

(73) Assignee: The Trustees for the Time Being of the Philip Edward Lawrence Risi Trust, North West Province (ZA)

(21) Appl. No.: 14/830,473

(22) Filed: Aug. 19, 2015

(30) Foreign Application Priority Data
Aug. 20, 2014 (ZA) 2014/06119
May 7, 2015 (ZA) 2015/03166

(51) Int. Cl. H01H 85/02; H01H 85/20; H01H 89/00; H01H 85/04

(52) U.S. Cl. CPC H01H 85/0241; H01H 85/04; H01H 85/20; H01H 89/00

(57) ABSTRACT

An electrical protection assembly has a pin insulator to define a first mounting structure, a fixed arm proximate an operatively upper end of the pin insulator, and an insulator arm extending from an operatively lower end of the pin insulator, with a proximate end of the insulator arm being removably securable to the pin insulator, and a first rocker arm pivotally mounted relative to the fixed arm. The first rocker arm terminates at a first end and a second end, with a fusible device being supportable between the first end of the first rocker arm and a distal end of the insulator arm, to define a fuse carrier section, and with a voltage surge protection unit being supportable between the second end of the first rocker arm and the operatively lower end of the pin insulator, to define an over voltage protection section.

THIS INVENTION relates to the distribution of electricity. In particular, the invention relates to a modular electrical protection assembly for connection between an electrical transmission line and electrical equipment.

In broad terms, this invention relates to an electrical protection assembly comprising a central insulator, a fuse carrier section and an over voltage protection section, with the fuse carrier section and the over voltage protection section being removably securable to the central insulator.

### Overall Combi Unit

According to a first aspect of the invention there is provided an electrical protection assembly for connection between an electrical power supply line and electrical equipment, the electrical protection assembly comprising:
a pin insulator to define a first mounting structure;
a fixed arm proximate an operatively upper end of the pin insulator, and an insulator arm extending from an operatively lower end of the pin insulator, with a proximate end of the insulator arm being removably securable to the pin insulator;
a first rocker arm pivotally mounted relative to the fixed arm, the first rocker arm terminating at a first end and a second end, with a fusible device being supportable between the first end of the first rocker arm and a distal end of the insulator arm, to define a fuse carrier section, and with a voltage surge protection unit being supportable between the second end of the first rocker arm and the operatively lower end of the pin insulator, to define an over voltage protection section.

In an embodiment, a second rocker arm assembly is pivotally mounted relative to the first rocker arm, proximate the first end of the first rocker arm, the second rocker arm assembly comprising a fuse carrier entry guide to snugly accommodate an upper end of the fusible device.

In an embodiment, the second rocker arm assembly comprises a releasing formation to facilitate the releasing of the fusible device and the voltage surge protection unit, depending on the pivoting direction of the second rocker arm assembly relative to the first rocker arm.

In an embodiment, the second rocker arm assembly comprises a spring loaded expulsion unit to propel the fusible device away from the second rocker arm assembly.

In an embodiment, a first biasing arrangement is provided to bias the second rocker arm assembly towards the first rocker arm.

In an embodiment, a first bracket is fitted to the distal end of the insulator arm, from which a fuse carrier support bracket extends, to pivotally receive a lower end of the fusible device.

In an embodiment, a first shock absorbing dampening arrangement is fitted to the first bracket, to dampen the pivoting fusible device when the fusible device falls out of the second rocker arm assembly.

In an embodiment, a second bracket extends operatively upwardly from the fixed arm, with the first rocker arm being pivotally mounted to the second bracket so as to be pivotable relative to the fixed arm, the first rocker arm being spaced apart from and mounted above the fixed arm.

In an embodiment, a second biasing arrangement is provided to bias the first end of the first rocker arm upwardly away from the fixed arm, using a first biasing means, and to bias the second end of the first rocker arm downwardly towards the fixed arm, using a second biasing means.

In an embodiment, the fuse carrier section and the over voltage protection section extend on opposite sides of the pin insulator.

In an embodiment, the second end of the first rocker arm comprises an arrestor entry guide to snugly accommodate an upper end of the voltage surge protection unit.

In an embodiment, a third bracket is fitted to the lower end of the pin insulator, from which an arrestor support bracket extends, to pivotally receive a lower end of the voltage surge protection unit.

In an embodiment, a second shock absorbing dampening arrangement is fitted to the third bracket, to dampen the pivoting voltage surge protection unit when the voltage surge protection unit falls out of the arrestor entry guide of the second end of the first rocker arm.

### Fuse Carrier Section

According to a second aspect of the invention there is provided an electrical protection assembly for connection between an electrical power supply line and electrical equipment, the electrical protection assembly comprising:
a pin insulator to define a first mounting structure;
a fixed arm proximate an operatively upper end of the pin insulator, and an insulator arm extending from an operatively lower end of the pin insulator, with a proximate end of the insulator arm being removably securable to the pin insulator;
a first rocker arm pivotally mounted relative to the fixed arm, the first rocker arm terminating at a first end and a second end, with a fusible device being supportable between the first end of the first rocker arm and a distal end of the insulator arm, to define a fuse carrier section.

In an embodiment, a second rocker arm assembly is pivotally mounted relative to the first rocker arm, proximate the first end of the first rocker arm, the second rocker arm assembly comprising a fuse carrier entry guide to snugly accommodate an upper end of the fusible device.

In an embodiment, the second rocker arm assembly comprises a releasing formation to facilitate the releasing of the fusible device by lifting the releasing formation upwardly.

In an embodiment, the second rocker arm assembly comprises a spring loaded expulsion unit to propel the fusible device away from the second rocker arm assembly.

In an embodiment, a first biasing arrangement is provided to bias the second rocker arm assembly towards the first rocker arm.

In an embodiment, a first bracket is fitted to the distal end of the insulator arm, from which a fuse carrier support bracket extends, to pivotally receive a lower end of the fusible device.

In an embodiment, a first shock absorbing dampening arrangement is fitted to the first bracket, to dampen the pivoting fusible device when the fusible device falls out of the second rocker arm assembly.

In an embodiment, a second bracket extends operatively upwardly from the fixed arm, with the rocker arm being pivotally mounted to the bracket so as to be pivotable relative to the fixed arm, the rocker arm being spaced apart and mounted above the fixed arm.

In an embodiment, a second biasing arrangement is provided to bias the first end of the first rocker arm upwardly away from the fixed arm, using a first biasing means, and to bias the second end of the first rocker arm downwardly towards the fixed arm, using a second biasing means.

In an embodiment, the second end of the first rocker arm terminates in an upwardly extending flange.

### Over Voltage Protection Section

According to a third aspect of the invention there is provided an electrical protection assembly for connection between an electrical power supply line and electrical equipment, the electrical protection assembly comprising:
a pin insulator to define a first mounting structure;
a fixed arm proximate an operatively upper end of the pin insulator;
a first rocker arm pivotally mounted relative to the fixed arm, the first rocker arm terminating at a first end and a second end, with a voltage surge protection unit being supportable between the second end of the first rocker arm and an operatively lower end of the pin insulator, to define an over voltage protection section.

In an embodiment, a second bracket extends operatively upwardly from the fixed arm, with the rocker arm being pivotally mounted to the bracket so as to be pivotable relative to the fixed arm, the rocker arm being spaced apart and mounted above the fixed arm.

In an embodiment, a second biasing arrangement is provided to bias the first end of the first rocker arm upwardly away from the fixed arm, using a first biasing means, and to bias the second end of the first rocker arm downwardly towards the fixed arm, using a second biasing means.

In an embodiment, the second end of the first rocker arm comprises an arrestor entry guide to snugly accommodate an upper end of the voltage surge protection unit.

In an embodiment, a third bracket is fitted to the lower end of the pin insulator, from which an arrestor support bracket extends, to pivotally receive a lower end of the voltage surge protection unit.

In an embodiment, a second shock absorbing dampening arrangement is fitted to the third bracket, to dampen the pivoting voltage surge protection unit when the voltage surge protection unit falls out of the arrestor entry guide of the second end of the first rocker arm.

In an embodiment, the first end of the first rocker arm terminates in an upwardly extending flange.

### Pin Insulator

According to a fourth aspect of the invention there is provided a pin insulator for an electrical protection assembly for connection between an electrical power supply line and electrical equipment, the pin insulator including first securing means to receive a fixed arm proximate an operatively upper end of the pin insulator, the pin insulator including second securing means to removably receive an insulator arm extending from an operatively lower end of the pin insulator.

The invention is now described by way of example with reference to the accompanying diagrammatic drawing, in which:

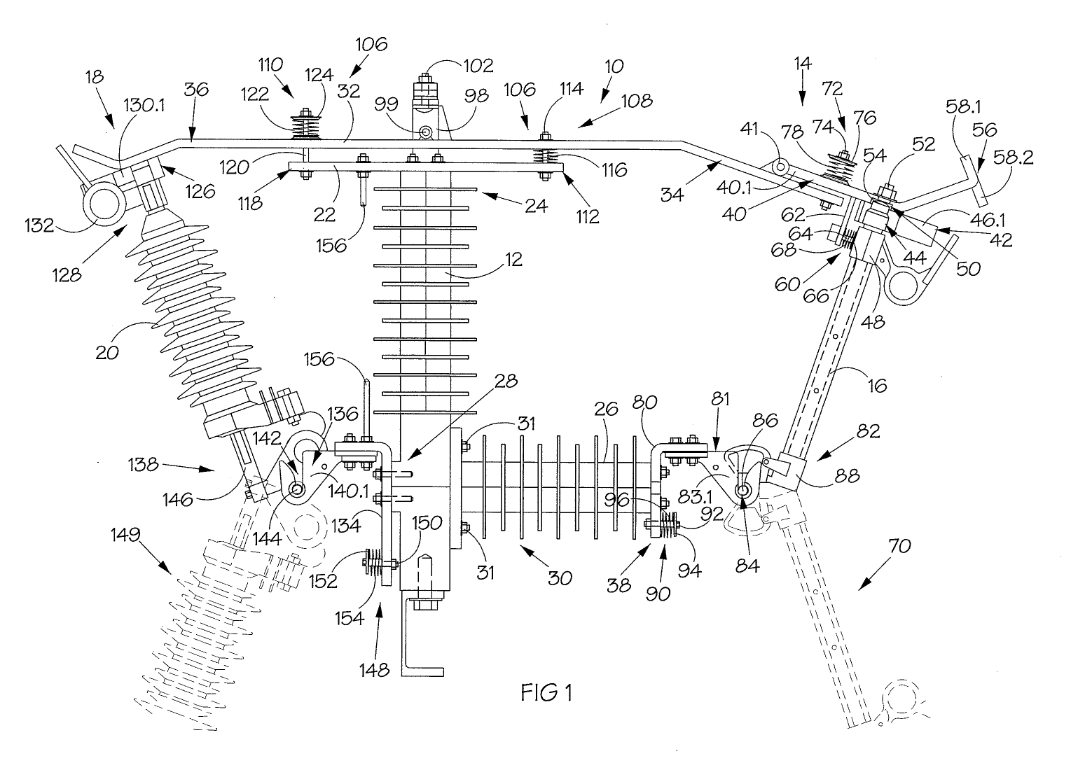

FIG. 1 shows a schematic view of a modular electrical protection assembly in accordance with a first embodiment of the invention, in its fully accessorized state;

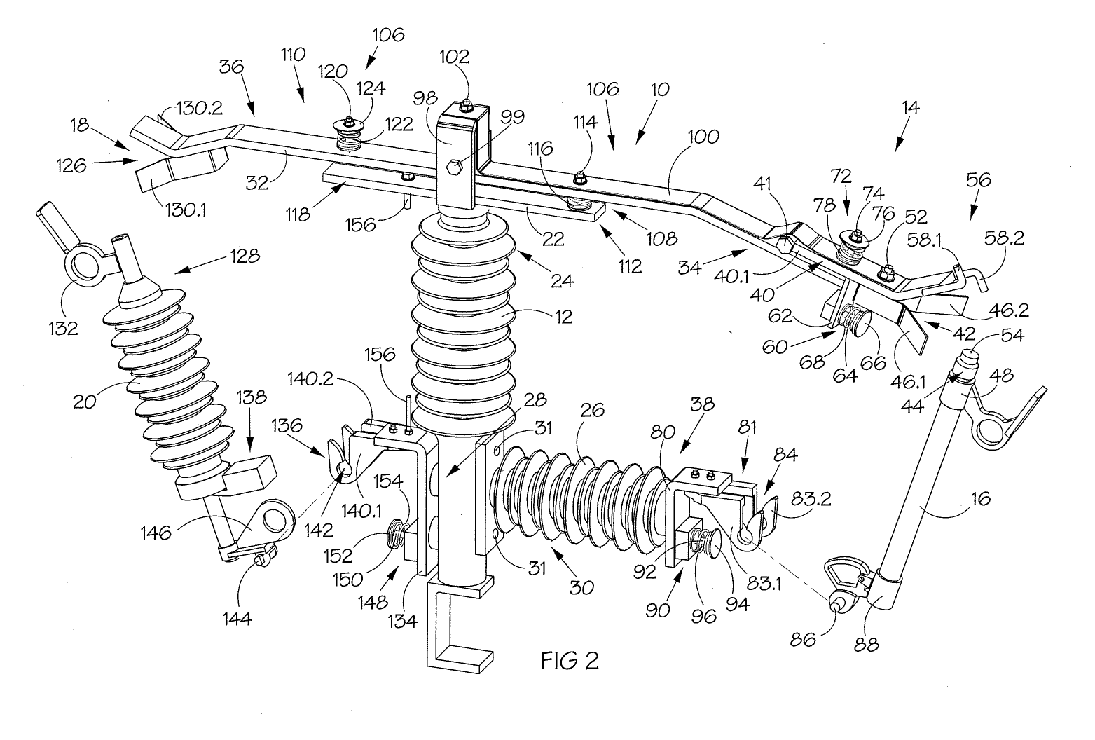

FIG. 2 shows a perspective view of the modular electrical protection assembly shown in FIG. 1;

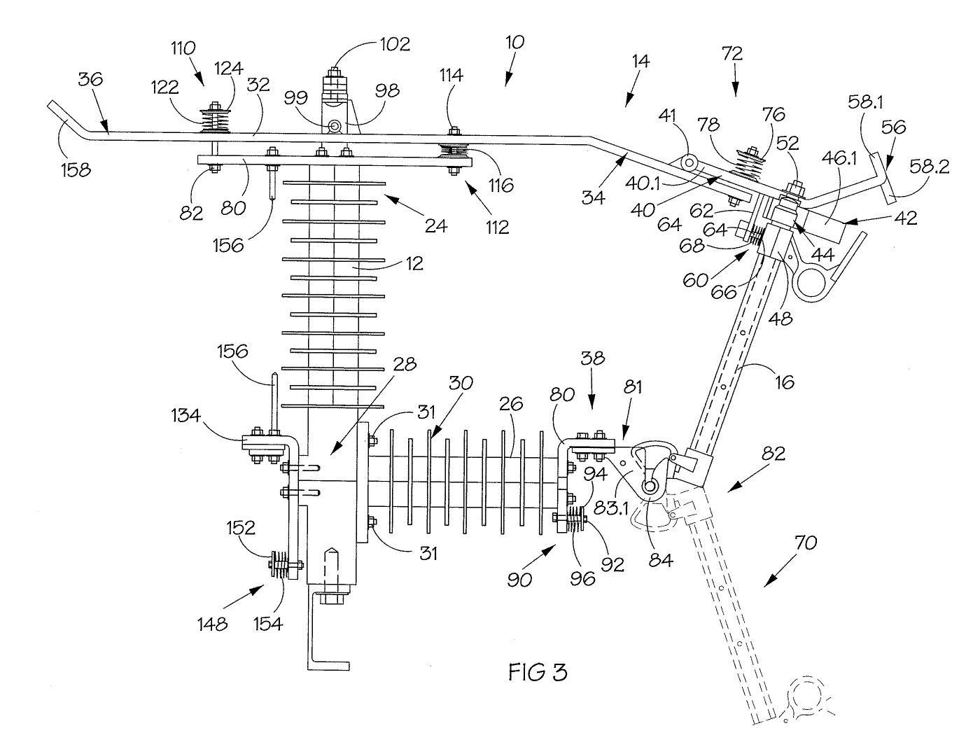

FIG. 3 shows a schematic view of a fuse carrier section of the assembly shown in FIG. 1, according to a second embodiment of the invention, the fuse carrier section being removably securable to a central pin insulator; and

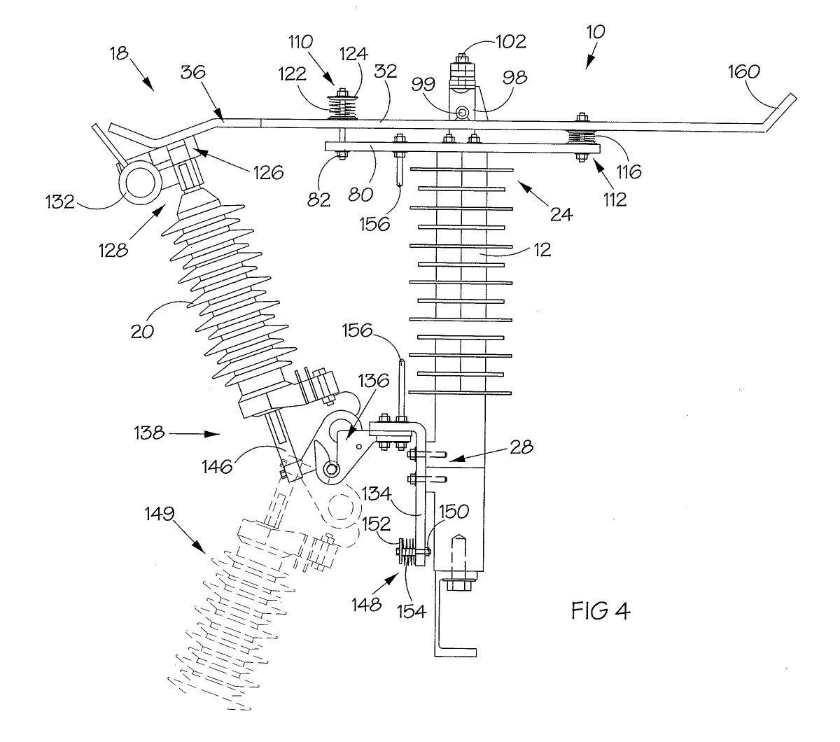

FIG. 4 shows a schematic view of an over voltage protection section of the assembly shown in FIG. 1, according to a third embodiment of the invention, the over voltage protection section also being removably securable to the central pin insulator.

Referring first to FIGS. 1 and 2, reference numeral 10 generally indicates an electrical protection assembly in accordance with the invention. The assembly 10 has a central pin insulator 12 to define a first mounting structure. On one side of the pin insulator 12 there is a fuse carrier section 14 comprising a fusible device 16, and on the other side of the pin insulator 12 there is an over voltage protection section 18 comprising a voltage surge protection unit 20.

The assembly 10 comprises a fixed arm 22 proximate an operatively upper end 24 of the pin insulator 12. An insulator arm 26 extends from an operatively lower end 28 of the pin insulator 12, substantially at right angles to the pin insulator 12. A proximate end 30 of the insulator arm 26 is removably securable, with bolts 31, for example, to the pin insulator 12.

A first rocker arm 32 is pivotally mounted relative to the fixed arm 22, the first rocker arm 32 terminating at a first end 34 and a second end 36. The fusible device 16 is thus supportable between the first end 34 of the first rocker arm 32 and a distal end 38 of the insulator arm 26, to define the fuse carrier section 14. In addition, the voltage surge protection unit 20 is supportable between the second end 36 of the first rocker arm 32 and the operatively lower end 28 of the pin insulator 12, to define the over voltage protection section 18.

A second rocker arm assembly 40 is pivotally 41 mounted relative to the first rocker arm 32, proximate the first end 34 of the first rocker arm 32. The second rocker arm assembly 40 comprises a fuse carrier entry guide 42 to snugly accommodate, so as to provide an electrical connection, an upper end 44 of the fusible device 16. The fuse carrier entry guide 42 comprises a pair of tapering arms 46.1, 46.2 to guide the upper end 44 of the fusible device 16, and in particular, a brass fuse release/insertion member 48 fitted to the upper end 44 of the fusible device 16, into position. To achieve the required electrical connection, a recessed contact 50 is bolted, with bolt 52, to the second rocker arm assembly 40 such that it extends into the fuse carrier entry guide 42, to snugly accommodate a protruding end 54 of the release/insertion member 48 fitted to the upper end 44 of the fusible device 16.

In an embodiment, the second rocker arm assembly 40 comprises a releasing formation 56, typically in the form of a pair of upwardly and downwardly extending bull horns 58.1, 58.2, to facilitate the releasing of the fusible device 16 and the voltage surge protection unit 20, depending on the pivoting direction of the second rocker arm assembly 40 relative to the first rocker arm 32. In particular, by lifting horns 58.2, the fusible device 16 can be released, and by pushing the other horn 58.1 downwardly, the voltage surge protection unit 20 can be released.

The second rocker arm assembly 40 comprises a spring loaded expulsion unit 60 to propel the fusible device 16 away from the second rocker arm assembly 40. The expulsion unit 60 comprises a flange 62 extending from a lower end of the second rocker arm assembly 40. An aperture is defined in the flange 62 to accommodate a movable pin 64, the pin 64 being connected to a contact member 66 (typically a stop washer) to abut against the upper end 44 of the fusible device 16. A coil spring 68 is provided between the flange 62 and the contact member 66, so as to bias the contact member 66 (and thus the upper end 44 of the fusible device 16) away from the flange 62. Thus, in use, when the fusible device 16 fuses, the expulsion unit 60 propels the fuse release/insertion member 48 fitted to the upper end 44 of the fusible device 16 outwardly away from the flange 62, thereby minimizing damage to the second rocker arm assembly 40 and assisting with the dropping out of the fusible device 16 into the ghosted configuration 70 shown in FIG. 1.

In an embodiment, a first biasing arrangement 72 is provided to bias the second rocker arm assembly 40 towards the first rocker arm 32. The first biasing arrangement 72 comprises a pair of aligned apertures defined at the first end 34 of the first rocker arm 32, through which a pin 74 extends, the pin 74 being bolted to the first end 34 of the first rocker arm 32. A contact member 76 (typically a stop washer) is secured to the end of the pin 74, with a coil spring 78 extending between the contact member 76 and an upper face of the second rocker arm assembly 40, so as to bias the second rocker arm assembly 40 towards the first rocker arm 32.

A first C-bracket 80 is releasably fitted to the distal end 38 of the insulator arm 26, from which a fuse carrier support bracket 81, complete with contacts, extends, to pivotally receive a lower end 82 of the fusible device 16. In particular, the fuse carrier support bracket 81 comprises a pair of spaced apart side flanges 83.1, 83.2, each defining a recess 84 for pivotally accommodating pins 86 extending from opposite ends of a first connector member 88 fitted to the lower end 82 of the fusible device 16.

In an embodiment, a first shock absorbing dampening arrangement 90 is fitted to the first bracket 80, to dampen the pivoting fusible device 16 when the fusible device 16 falls out of the second rocker arm assembly 40 (and in particular, when it is propelled by the action of the spring loaded expulsion unit 60 away from the second rocker arm assembly 40).

The first shock absorbing dampening arrangement 90 comprises a pin 92 secured to the first bracket 80, a contact member 94 (typically a stop washer) that is movable relative to the pin 92, which the fusible device 16 can strike after being propelled away from the second rocker arm assembly 40, and a coil spring 96 extending between the first bracket 80 and the contact member 94, to dampen the falling fusible device 16.

In an embodiment, a second bracket 98 extends operatively upwardly from the fixed arm 22, with the first rocker arm 32 being pivotally 99 mounted to the second bracket 98 so as to be pivotable relative to the fixed arm 22, the first rocker arm 32 being spaced apart from, and mounted above, the fixed arm 22. A copper strip conductor 100 (best shown in FIG. 2) extends from an upper face of the second bracket 98, to which it is bolted in place with bolt 102, along the first rocker arm 32, onto the second rocker arm assembly 40, and ultimately terminating, and bolted in place with bolt 52, on the second rocker arm assembly 40 proximate the releasing formation 56.

A second biasing arrangement 106 is provided to bias the first end 34 of the first rocker arm 32 upwardly away from the fixed arm 22, using a first biasing means 108, and to bias the second end 36 of the first rocker arm 32 downwardly towards the fixed arm 22, using a second biasing means 110.

The first biasing means 108 comprises a pair of aligned apertures defined at a first end 112 of the fixed arm 22 and through an adjacent portion of the first rocker arm 32, through which a pin 114 extends. A coil spring 116 extends between a lower face of the first rocker arm 32 and an upper face of the fixed arm 22, so as to bias the first end 34 of the first rocker arm 32 upwardly away from the fixed arm 22.

The second biasing means 110 comprises a pair of aligned apertures defined at a second end 118 of the fixed arm 22 and through an adjacent portion of the first rocker arm 32, through which a pin 120 extends. A coil spring 122 extends between an upper face of the first rocker arm 32 and a contact member 124 (typically a stop washer) secured to the pin 120, so as to bias the second end 36 of the first rocker arm 32 downwardly towards the fixed arm 22.

In an embodiment, the second end 36 of the first rocker arm 32 comprises an arrestor entry guide 126 to snugly accommodate an upper end 128 of the voltage surge protection unit 20. The arrestor entry guide 126 comprises a pair of tapering arms 130.1, 130.2 to guide the upper end 128 of the voltage surge protection unit 20, and in particular, an arrestor release/insertion member 132 fitted to the upper end 128 of the voltage surge protection unit 20, into position.

A third C-bracket 134 is releasably fitted to the lower end 28 of the pin insulator 12, from which an arrestor support bracket 136 (with no contacts) extends, to pivotally receive a lower end 138 of the voltage surge protection unit 20. In particular, the arrestor support bracket 136 comprises a pair of spaced apart side flanges 140.1, 140.2, each defining a recess 142 for pivotally accommodating pins 144 extending from opposite ends of a second connector member 146 fitted to the lower end 138 of the voltage surge protection unit 20.

In an embodiment, a second shock absorbing dampening arrangement 148 is fitted to the third bracket 134, to dampen the pivoting voltage surge protection unit 20 when the voltage surge protection unit 20 falls out of the arrestor entry guide 126 of the second end 36 of the first rocker arm 32, into its ghosted configuration 149 shown in FIG. 1.

The second shock absorbing dampening arrangement 148 comprises a pin 150 secured to the third bracket 134, a contact member 152 (typically a stop washer) that is movable relative to the pin 150, which the voltage surge protection unit 20 can strike, and a coil spring 154 extending between the third bracket 134 and the contact member 152, to dampen the falling voltage surge protection unit 20.

Arcing horns 156 extend between the fixed arm 22 and the third bracket 134.

Turning now to FIG. 3, a second embodiment of the invention is shown, comprising a fuse carrier section 14 only, which is removably securable to the central pin insulator 12. The components in FIG. 3 are substantially the same as the fully accessorized version shown in FIGS. 1 and 2, and have thus been numbered similarly. The primary difference is that, since the over voltage protection section 18 is not desired/required, the second end of the first rocker arm 32 terminates in an upwardly extending flange 158. The remaining components are the same as those described above with reference to FIGS. 1 and 2, and will thus not be described again.

Turning now to FIG. 4, a third embodiment of the invention is shown, comprising a over voltage protection section 18 only, which is removably securable to the central pin insulator 12. The components in FIG. 4 are substantially the same as the fully accessorized version shown in FIGS. 1 and 2, and have thus been numbered similarly. The primary difference is that, since the fuse carrier section 14 is not desired/required, the first end of the first rocker arm 32 terminates in an upwardly extending flange 160. The remaining components are the same as those described above with reference to FIGS. 1 and 2, and will thus not be described again.

1. An electrical protection assembly for connection between an electrical power supply line and electrical equipment, the electrical protection assembly comprising:
a pin insulator to define a first mounting structure;
a fixed arm proximate an operatively upper end of the pin insulator, and an insulator arm extending from an operatively lower end of the pin insulator, with a proximate end of the insulator arm being removably securable to the pin insulator; and
a first rocker arm pivotally mounted relative to the fixed arm, the first rocker arm terminating at a first end and a second end, with a fusible device being supportable between the first end of the first rocker arm and a distal end of the insulator arm, to define a fuse carrier section, and with a voltage surge protection unit being supportable between the second end of the first rocker arm and the operatively lower end of the pin insulator, to define an over voltage protection section.

2. The electrical protection assembly of claim 1, wherein a second rocker arm assembly is pivotally mounted relative to the first rocker arm, proximate the first end of the first rocker arm, the second rocker arm assembly comprising a fuse carrier entry guide to snugly accommodate an upper end of the fusible device.

3. The electrical protection assembly of claim 2, the second rocker arm assembly comprises a releasing formation to facilitate the releasing of the fusible device and the voltage surge protection unit, depending on the pivoting direction of the second rocker arm assembly relative to the first rocker arm.

4. The electrical protection assembly of claim 2, wherein the second rocker arm assembly comprises a spring loaded expulsion unit to propel the fusible device away from the second rocker arm assembly.

5. The electrical protection assembly of claim 2, wherein a first biasing arrangement is provided to bias the second rocker arm assembly towards the first rocker arm.

6. The electrical protection assembly of claim 2, wherein a first bracket is fitted to the distal end of the insulator arm, from which a fuse carrier support bracket extends, to pivotally receive a lower end of the fusible device.

7. The electrical protection assembly of claim 6, wherein a first shock absorbing dampening arrangement is fitted to the first bracket, to dampen the pivoting fusible device when the fusible device falls out of the second rocker arm assembly.

8. The electrical protection assembly of claim 1, wherein a second bracket extends operatively upwardly from the fixed arm, with the first rocker arm being pivotally mounted to the second bracket so as to be pivotable relative to the fixed arm, the first rocker arm being spaced apart from and mounted above the fixed arm.

9. The electrical protection assembly of claim 1, wherein a second biasing arrangement is provided to bias the first end of the first rocker arm upwardly away from the fixed arm, using a first biasing means, and to bias the second end of the first rocker arm downwardly towards the fixed arm, using a second biasing means.

10. The electrical protection assembly of claim 1, wherein the fuse carrier section and the over voltage protection section extend on opposite sides of the pin insulator.

11. The electrical protection assembly of claim 1, wherein the second end of the first rocker arm comprises an arrestor entry guide to snugly accommodate an upper end of the voltage surge protection unit.

12. The electrical protection assembly of claim 1, wherein a third bracket is fitted to the lower end of the pin insulator, from which an arrestor support bracket extends, to pivotally receive a lower end of the voltage surge protection unit.

13. The electrical protection assembly of claim 12, wherein a second shock absorbing dampening arrangement is fitted to the third bracket, to dampen the pivoting voltage surge protection unit when the voltage surge protection unit falls out of the arrestor entry guide of the second end of the first rocker arm.

14. An electrical protection assembly for connection between an electrical power supply line and electrical equipment, the electrical protection assembly comprising:
a pin insulator to define a first mounting structure;
a fixed arm proximate an operatively upper end of the pin insulator, and an insulator arm extending from an operatively lower end of the pin insulator, with a proximate end of the insulator arm being removably securable to the pin insulator; and
a first rocker arm pivotally mounted relative to the fixed arm, the first rocker arm terminating at a first end and a second end, with a fusible device being supportable between the first end of the first rocker arm and a distal end of the insulator arm, to define a fuse carrier section.

15. The electrical protection assembly of claim 14, wherein a second rocker arm assembly is pivotally mounted relative to the first rocker arm, proximate the first end of the first rocker arm, the second rocker arm assembly comprising a fuse carrier entry guide to snugly accommodate an upper end of the fusible device.

16. The electrical protection assembly of claim 15, wherein the second rocker arm assembly comprises a releasing formation to facilitate the releasing of the fusible device by lifting the releasing formation upwardly.

17. The electrical protection assembly of claim 15, wherein the second rocker arm assembly comprises a spring loaded expulsion unit to propel the fusible device away from the second rocker arm assembly.

18. An electrical protection assembly for connection between an electrical power supply line and electrical equipment, the electrical protection assembly comprising:
a pin insulator to define a first mounting structure;
a fixed arm proximate an operatively upper end of the pin insulator; and
a first rocker arm pivotally mounted relative to the fixed arm, the first rocker arm terminating at a first end and a second end, with a voltage surge protection unit being supportable between the second end of the first rocker arm and an operatively lower end of the pin insulator, to define an over voltage protection section.

19. The electrical protection assembly of claim 18, wherein a second bracket extends operatively upwardly from the fixed arm, with the rocker arm being pivotally mounted to the bracket so as to be pivotable relative to the fixed arm, the rocker arm being spaced apart and mounted above the fixed arm.

20. The electrical protection assembly of claim 18, wherein a second biasing arrangement is provided to bias the first end of the first rocker arm upwardly away from the fixed arm, using a first biasing means, and to bias the second end of the first rocker arm downwardly towards the fixed arm, using a second biasing means.

21. The electrical protection assembly of claim 18, wherein the second end of the first rocker arm comprises an arrestor entry guide to snugly accommodate an upper end of the voltage surge protection unit.

22. A pin insulator for an electrical protection assembly for connection between an electrical power supply line and electrical equipment, the pin insulator including first securing means to receive a fixed arm proximate an operatively upper end of the pin insulator, the pin insulator including second securing means to removably receive an insulator arm extending from an operatively lower end of the pin insulator.
